(19) United States
(12) Patent Application Publication
(10) Pub. No.: US 2014/0207692 A1
(43) Pub. Date: Jul. 24, 2014

(54) ENERGY MANAGEMENT FOR PET RECYCLING SYSTEMS

(71) Applicant: KRONES AG, Neutraubling (DE)

(72) Inventor: Norbert Peters, Flensburg (DE)

(73) Assignee: KRONES AG, Neutraubling (DE)

(21) Appl. No.: 14/091,427

(22) Filed: Nov. 27, 2013

(30) Foreign Application Priority Data
Jan. 24, 2013 (DE) 10 2013 201 116.4

(51) Int. Cl. G06Q 10/00

(52) U.S. Cl. CPC G06Q 10/30
USPC 705/308

(57) ABSTRACT

A method for operating a plastics recycling system, including: detecting the energy consumption of individual or several or all energy consumers of the plastics recycling system, detecting an operating state of the plastics recycling system, identifying the energy consumers required for the operating state, using a hierarchy of the energy consumers depending on their energy consumption and/or their operating mode and/or the operating state of the plastics recycling system, and supplying the required energy consumers with energy taking into account said hierarchy, where the maximum peak power supplied to the entirety of the required energy consumers is smaller than the sum of the rated peak powers of the individual required energy consumers.

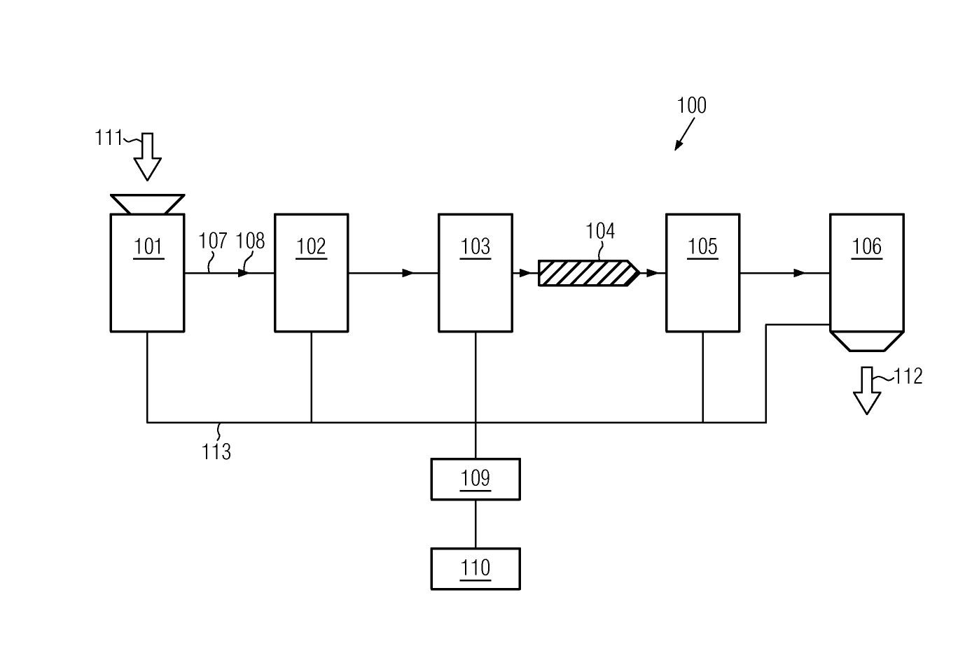

### CROSS-REFERENCE TO RELATED APPLICATION

The present application claims the benefit of priority of German Application No. 10 2013 201 116.4, filed Jan. 24, 2013. The entire text of the priority application is incorporated herein by reference in its entirety.

### FIELD OF THE DISCLOSURE

The disclosure relates to a method and to a system of the kind described in the preamble for managing energy consumption in plastics recycling operations.

### BACKGROUND

Today's plastics recycling systems, such as systems for the recycling of polyethylene terephthalate (PET), are configured in such a way that the whole maximum power for all energy-consuming components of a system can be controlled, at any time, by the hardware, e.g. busbars, master switches, transformers, generators etc.

One of the disadvantages thereof is that electric peak loads of a so-dimensioned system will be charged by the energy supplier although they may never occur, or occur only rarely, in practice.

### SUMMARY OF THE DISCLOSURE

It is one aspect of the disclosure to improve a plastics recycling system, in particular with regard to the efficiency and configuration thereof.

A method according to the disclosure is capable of detecting the energy consumption of individual or several or all energy consumers of the plastics recycling system.

Also, an operating state of the plastics recycling system may be detected, and an identification of the energy consumers required for the operating state may be realized.

To this end, it is possible to take into account a hierarchy of the energy consumers depending on their energy consumption and/or their operating mode and/or the operating state of the plastics recycling system when supplying the required energy consumers with energy, wherein the maximum peak power supplied to the entirety of the required energy consumers may be smaller than the sum of the rated peak powers of all individual, respectively all required energy consumers.

The energy, respectively power provided in the system can, thus, be limited and managed in an intelligent way so that the provided maximum energy may be smaller than the sum of the maximum energies of the individual required energy consumers because, for example, only the currently needed energy consumers are supplied with energy, respectively the energy consumers are supplied with energies according to a predetermined hierarchy. At the same time, it can be prevented that all energy consumers are operated with a 100% power simultaneously. Incidentally, it is possible with this design that the energy is supplied to individual energy consumers continuously and/or clocked.

A clocked energy supply includes both the possibility of a regularly clocked energy supply and the possibility of an irregularly clocked energy supply, e.g. a one-time activation/deactivation of the energy consumer.

This intelligent energy management has the advantage, inter alia, that the system, respectively the hardware components, e.g. busbars, master switches, transformers, generators etc., can be dimensioned smaller allowing energy to be saved.

Also, the possible size reduction of said hardware components allows the realization of a more compact and more space-saving construction of the system.

It is important to note that the terms load, energy and power refer to electrical loads, electric energies and electrical powers. Furthermore, unless explicitly pointed out differently, the term material shall refer to plastic materials, in particular to PET plastics.

The required energy consumers may be supplied with energy for a predetermined energy consumer operating time and/or at a predetermined energy consumer turn-on time, depending on the hierarchy of the energy consumers and/or their operating mode and/or the operating state of the plastics recycling system.

In other words, the operating time and/or the turn-on time for each individual energy consumer may be controlled and determined individually by the intelligent energy management.

This has the advantage, inter alia, that a pinpointed and individual start-up of the energy consumers, i.e. a precise individual controlling of the energy supply of the individual energy consumers with regard to the energy consumer operating time and energy consumer turn-on time, can result in the saving of energy with regard to the sum of the energies consumed by the energy consumers.

Thus, it is possible, for example, that required energy consumers that reach their readiness for operation faster than other required energy consumers are turned on later than those energy consumers that require more time for reaching their state of readiness. By this, energy can be saved, for example, particularly when heating up/starting up the plastics recycling system as other energy consumers already turned on and ready for operation need not wait unnecessarily at their point of readiness for the readiness of other energy consumers, thus losing energy that is not productively utilized.

In addition, it is possible that the energy supply of all, or of a selection of the required energy consumers is reduced or increased at a predetermined point in time during the operation and for a predetermined time of operation.

This can enhance, for example, the operational safety of the plastics recycling system. At the same time, energy consumers consuming more energy than other energy consumers may be restricted temporarily with regard to their energy consumption, respectively power, so as to be able to avoid an overloading of the energy supply of the plastics recycling system.

Moreover, the detection of the energy consumption of each individual energy consumer of the plastics recycling system and/or the detection of the operating state of the plastics recycling system and/or the identification of the energy consumers required for the operating state and/or the creation of a hierarchy of the energy consumers may include the detection of an input by an operator and/or the reading out of predetermined parameters from a database regarding the energy consumption of the energy consumer and/or the operating state of the plastics recycling system and/or the hierarchy of the energy consumers.

For example, a database may include the characteristic data of energy consumers, including the peak power thereof, thus allowing the calculation, for example, of the theoretical maximum peak power of the system as the sum of all peak powers of the individual energy consumers from said characteristic data.

In addition, a database may also contain predefined parameters for specifying a hierarchy of the energy consumers, for example depending on the required operating state of the system, respectively on the required operating state of the energy consumer.

It is also conceivable that at least one ambient parameter of the plastics recycling system can be measured, and that the supply of the required energy consumers with energy may be realized by taking into account said at least one ambient parameter.

For example, the at least one ambient parameter may be the ambient temperature and/or the ambient humidity and/or the ambient pressure and/or the time of day.

Advantageously, the energy consumption can thus be optimized depending on the ambient conditions.

For example, if the ambient temperature and/or the ambient humidity change on account of seasonal changes and/or changes depending on the time of day, the energy supply can be regulated, in particular reduced, by heating and/or cooling components and/or drying components.

Also, the energy supply of the energy consumers may be regulated depending on the time of day, for example, in order to profit by lower overnight rates offered by an energy supplier. Incidentally, an operating state of the plastics recycling system may imply the heating up/starting up, the shutting down, the continuous or clocked operation, the operation for various loads, as well as specific system configurations for specific process steps in the plastics recycling, such as washing processes, stirring processes, pumping processes, aeration processes, drying processes, crystallization processes, conveying processes, extruder processes, filtering processes, granulating processes, etc.

As a rule, the operating state, respectively operating process of the heating up/starting up of the plastics recycling system may necessitate the greatest demand for current/energy.

The intelligent energy management is capable of prognosticating the required energy supply for a given operating state of the plastics recycling system, e.g. determine a maximum instantaneous energy consumption and/or, for example, compare an actual operating state with a desired operating state.

The intelligent energy management is capable of flexibly reacting on unanticipated deviations from the prognosticated energy demand, e.g. caused by an open hall entrance which prevents the system from heating up within the normal time specified for this purpose, and controlled variations of operating times of selected energy consumers, for example, can ensure that the desired operating state of the plastics recycling system can be achieved also in non-standard ambient conditions.

By using a hierarchy of the energy consumers, respectively the required energy consumers the intelligent energy management according to the disclosure is capable of supplying the energy consumers with energy depending on their energy consumption and/or their operating mode and/or the operating state of the plastics recycling system.

The criteria according to which said hierarchy can be created and/or used may include or consider, inter alia, for example the following criteria: energy consumer operating time, energy consumer turn-on time, operational readiness requirement of the energy consumer, power/energy demand of the energy consumer, relevance of the energy consumer for a given operating state of the plastics recycling system, operating mode of the energy consumer, operating state of the plastics recycling system etc.

Aforementioned criteria may be used for a hierarchic classification of the energy consumers of the plastics recycling system.

In addition, energy consumers of the plastics recycling system may be classified for a given operating state of the system, for example, into at least four relevance classes on the basis of their operating mode, e.g. into energy consumers that are turned on for the given operating state of the system and are operated continuously with a power of 100% (Relevance Class I), into energy consumers that are turned on for the given operating state of the system and are operated continuously with a power of less than 100% (Relevance Class II), into energy consumers that are turned on for the given operating state of the system in clock mode and are operated with a power of 100% in clock mode (Relevance Class III), and into energy consumers that are turned on for the given operating state of the system in clock mode and are operated with a power of less than 100% in clock mode (Relevance Class VI).

For example, energy consumers that are only optional for the given operating state of the system and/or that only require an insignificant amount of energy, respectively power, e.g. that have an energy/power demand<<1%, may be classified, for example, into a Relevance Class V.

The energy supply of the required energy consumers may, thus, be realized in accordance with a hierarchy, which is capable of considering aforementioned criteria, e.g. on the basis of assigned relevance classes.

In other words, energy consumers of Relevance Class I may be supplied continuously with energy for a continuous operation with 100% of power, while energy consumers of Relevance Class II are supplied continuously with energy for a continuous operation with less than 100% of power. Energy consumers of Relevance Class III may be supplied with energy in clock mode for an operation with 100% of power, while energy consumers of Relevance Class VI are supplied with energy in clock mode for an operation with less than 100% of power. Accordingly, energy consumers of Relevance Class V may be supplied with energy continuously or clocked for the operation with powers<<1%.

It should be mentioned that although the classification into relevance classes is capable of influencing and specifying the hierarchy according to which the energy consumers can be supplied with energy, the hierarchy does not necessarily have to be specified definitely.

The hierarchy according to which energy consumers are supplied with energy may equally be determined by the criteria recited further up. An energy consumer of a lower relevance class may be turned on earlier, for example, than an energy consumer of a higher relevance class as the energy consumer of the lower relevance class needs, for example, more time to reach its readiness for operation.

Also, energy consumers assigned to the same relevance class may, for example, be further classified according to the priority among said energy consumers, in which the turn-on time thereof, the operating time etc. are considered depending on the operating state of the plastics recycling system.

That is, an energy consumer hierarchy may be specified for a given operating state of the system, which is based, inter alia, on the aforementioned criteria and may include, for example, in particular a classification into relevance classes, wherein an operating state in which all required energy consumers, respectively all energy consumers are assigned to Relevance Class I is precluded.

However, depending on the operating state of the system, respectively of the energy consumer, different relevance classes may be assigned to an energy consumer. In other words, the classification of the energy consumers into relevance classes may be realized dynamically, i.e. an energy consumer may be readily switched between relevance classes.

Hence, a system for the recycling of plastic according to the disclosure may comprise a plurality of energy consumers, as well as at least one intelligent energy management unit in communication with said energy consumers and in communication with a central control unit for the energy consumers of the system and/or in communication with decentralized control units of the energy consumers of the system.

The intelligent energy management unit may be configured to detect the energy consumption of each individual energy consumer of the plastics recycling system, detect the operating state of the plastics recycling system, identify the energy consumers required for the operating state, use a hierarchy of the energy consumers depending on their energy consumption and/or their operating mode and/or the operating state of the plastics recycling system, and allow the required energy consumers to be supplied with energy by taking into account said hierarchy, wherein the maximum peak power which the energy management unit can make available to the entirety of the required energy consumers is smaller than the sum of the rated peak powers of all individual, respectively all required energy consumers.

Examples for energy consumers, respectively required energy consumers of a plastics recycling system are in particular disintegrating and/or washing units for the plastic materials fed to the recycling process, and units for conveying plastic materials and/or other materials, drive units, stirrer units, ventilation units, fan units, pumping units, filter units, screening units, granulating units, drying units, extruder units, etc.

In-house tests and simulations have shown that a system operated with an intelligent energy management unit according to the disclosure, and/or systems that were designed, configured from the beginning and/or retrofitted by taking into account an intelligent energy management structure according to the disclosure have achieved energy savings of more than 30% as compared to a system working without an energy management unit, respectively energy management structure according to the disclosure.

### BRIEF DESCRIPTION OF THE DRAWING

The drawing FIGURE shows by way of example a schematic example of a plastics recycling system.

### DETAILED DESCRIPTION OF THE PREFERRED EMBODIMENT

The FIGURE shows an example of a plastics recycling system which may include, for example, at least seven different systems components, respectively energy consumers 101, 102, 103, 104, 105, 106 and 107.

Recyclable plastic material may be fed 111 to a first energy consumer 101. Said energy consumer 101 may be, for example, a buffer silo with a stirrer. The stirrer may be operated continuously or in clock mode, and with 100% of power or less than 100% of power. Preferably, it is operated in clock mode, however, with a power of less than 100%

In other words, the energy consumer 101 may be classified into one of the above-described relevance classes, e.g. preferably Reference Class IV.

System component, respectively energy consumer 101 may, of course, include yet other (non-illustrated) energy consumers, e.g. a continuously operated flow weigher and/or additional optionally operated weighers which may be operated according to the electromagnetic force balance principle. These other mentioned energy consumers, too, may be classified into such relevance classes.

At least one material conveying unit 107 with a conveying direction 108 may transport material to be processed between the system components and, for example, can be equally operated continuously or clocked, with 100% of power or less than 100% of power.

Preferably, the material conveying unit 107 may be operated continuously with less than 100% of power, viz. be assigned, for example, to Relevance Class II.

Another system component, respectively another energy consumer 102 may be a washing unit which may be loaded by the material conveying unit 107 with material to be processed from the first system component 101.

The washing unit, including the components associated with it, may be operated continuously or clocked, with 100% of power or less than 100% of power. In this connection it may be preferred, for example, that the washing unit including, for example, (non-illustrated) prewashing and/or intensive washing units, density separating units, pumping and/or circulating units, etc. can be operated continuously with a power of less than 100%, that is, may be assigned to Relevance Class II.

The cleaned material to be recycled can then be transported further to a system component 103 which is constructed, for example, as a drying unit and/or crystallization unit and in which the moist material to be recycled can be heated, crystallized and dried. This system component, respectively this energy consumer 103, too, can be operated continuously or in clock mode, with 100% of power or less than 100% of power, i.e. this component 103 can preferably be assigned to Relevance Class I.

In another process step of the recycling of plastic material the cleaned and dried plastic material to be recycled can be processed to a molten mass in a system component 104, e.g. an extruder. To improve, respectively obtain the viscosity of the molten mass it is possible to produce a vacuum at the extruder by means of (non-illustrated) vacuum pumps. The system component 104, including possible components associated with it, e.g. said vacuum pumps, filter units, screen changers, etc. may equally be operated continuously or in clock mode, with 100% of power or less than 100% of power. In this connection a continuous operation with a power of less than 100% may be preferred, i.e. system component 104 may be assigned to Relevance Class II.

The produced molten mass can then be granulated in another system component 105, e.g. an underwater granulation unit, wherein said system component, respectively energy consumer 105, again, may be operated continuously or in clock mode, with 100% of power or less than 100% of power. Preferably, the system component 105 may be operated continuously, however, with a power of less than 100%, i.e. may be assigned to Relevance Class II.

Finally, the produced, respectively recovered granular plastic material may be transported further to a system component 106, e.g. a bagging station where the granular plastic material can cool down.

In order to avoid undesired lumping of the granular plastic material stirring may be performed by a (non-illustrated) stirrer continuously or in clock mode. Preferably, said stirrer may be operated in clock mode, with a power of less than 100%, i.e. may be assigned to Relevance Class IV.

From system component 106 the so recycled plastic material can be fed in the form of granules to new uses, respectively production steps 112 (not illustrated).

The system components, respectively energy consumers 101, 102, 103, 104, 105, 106 and 107, including possible (non-illustrated) energy consumers associated therewith, may be connected by a line 113 for communicating control commands and/or data to an intelligent energy management unit 109 and/or a central control unit 110 and/or to (non-illustrated) decentralized control units of the energy consumers of the system.

All mentioned energy consumers may be assigned to the relevance classes described above by way of examples. As was mentioned before, this relevance class assignment may be realized dynamically, however, and be depending on the operating state of the system and/or the operating state of the energy consumer.

It was equally mentioned above that although the classification into relevance classes is capable of influencing and specifying the hierarchy according to which the energy consumers 101, 102, 103, 104, 105, 106 and 107 can be supplied with energy, the hierarchy does not necessarily have to be specified definitely.

The hierarchy according to which the energy consumers 101, 102, 103, 104, 105, 106 and 107 can be supplied with energy may equally be determined by the criteria recited further up, such as the energy consumer operating time, the energy consumer turn-on time, the operational readiness requirement of the energy consumer, the power/energy demand of the energy consumer, the relevance of the energy consumer for a given operating state of the plastics recycling system 100, the operating mode of the energy consumer, the operating state of the plastics recycling system 100 etc.

An energy consumer of a lower relevance class may be turned on earlier, for example, than an energy consumer of a higher relevance class as the energy consumer of the lower relevance class needs, for example, more time to reach its readiness for operation.

Also, for example, energy consumers assigned to the same relevance class may be subjected to a further classification according to priorities among said energy consumers in which, for example, the turn-on time thereof, the operating time etc. are considered depending on the operating state of the plastics recycling system 100. On the basis of this hierarchy, respectively these relevance classes, depending on the energy consumption and/or the operating mode of the given energy consumer and/or the operating state of the plastics recycling system, the intelligent energy management unit 109 is capable of supplying the required energy consumers with energy, continuously and/or clocked, taking into account said hierarchy, respectively relevance classes, wherein the maximum peak power which the energy management unit can make available to the entirety of the required energy consumers is smaller than the sum of the rated peak powers of all individual, respectively all required energy consumers.

A first operating state of the system, respectively system operating process, e.g. the heating up/starting up of the system, can be characterized, inter alia, in that energy consumer 101 may be assigned Relevance Class II, energy consumer 102 may be assigned Relevance Class II, energy consumer 103 may be assigned Relevance Class I, energy consumer 104 may be assigned Relevance Class II, energy consumer 105 may be assigned Relevance Class II, energy consumer 106 may be assigned Relevance Class IV, and energy consumer 107 may be assigned Relevance Class II.

Owing to different requirements for the operational readiness of the energy consumers, e.g. different times required for reaching the readiness for operation, it may be, however, that for example energy consumer 104 with Relevance Class II assigned to it is turned on prior to energy consumer 103 with Relevance Class I assigned to it because energy consumer 104 requires, for example, more time than energy consumer 103 to reach operational readiness.

An exemplary second operating state of the system, e.g. upon a first utilization of the system, can be characterized, inter alia, in that energy consumer 101 may be assigned Relevance Class IV, energy consumer 102 may be assigned Relevance Class II, energy consumer 103 may be assigned Relevance Class I, energy consumer 104 may be assigned Relevance Class II, energy consumer 105 may be assigned Relevance Class II, energy consumer 106 may be assigned Relevance Class IV, and energy consumer 107 may be assigned Relevance Class II.

In an exemplary third operating state of the system, e.g. upon a second utilization of the system, which may be increased as compared to the above first utilization, the following exemplary classification of the energy consumers may be realized: energy consumer 101 may be assigned Relevance Class II, energy consumer 102 may be assigned Relevance Class II, energy consumer 103 may be assigned Relevance Class I, energy consumer 104 may be assigned Relevance Class II, energy consumer 105 may be assigned Relevance Class II, energy consumer 106 may be assigned Relevance Class III, and energy consumer 107 may be assigned Relevance Class I.

On the basis of this exemplary classification of the energy consumers into relevance classes the intelligent energy management unit 109 is capable of supplying in a given operating state of the system, continuously and/or clocked, the energy consumers with corresponding energy, viz. hierarchically according to their assigned relevance class and/or hierarchically according to predetermined values for the energy consumer turn-on time, the energy consumer operating time etc.

It is important to note, for the sake of completeness, that the plastics recycling system 100 described herein by way of example may be combined with features from the preceding general part of the description. For example, the recycling system 100 may comprise a sensor system for detecting ambient condition parameters, such as ambient temperature and/or the ambient humidity and/or the ambient pressure and/or the time of day.

The supply of the energy consumers of the system 100 can then be accomplished, for example, by taking into account at least one of the aforementioned ambient parameters.

What is claimed is:

1. A method for operating a plastics recycling system, comprising:
detecting the energy consumption of one of individual, a plurality of, and all energy consumers of the plastics recycling system,
detecting an operating state of the plastics recycling system,
identifying the energy consumers required for the operating state,
using a hierarchy of the energy consumers depending on one of their energy consumption, their operating mode, the operating state of the plastics recycling system, and any combination thereof, and
supplying the required energy consumers with energy taking into account the hierarchy, wherein the maximum peak power supplied to the entirety of the required energy consumers is smaller than the sum of the rated peak powers of the individual required energy consumers.

2. The method according to claim 1, and supplying the required energy consumers with energy for one of a predetermined energy consumer operating time, at a predetermined energy consumer turn-on time, and a combination thereof, depending on one of the hierarchy of the energy consumers, their operating mode, the operating state of the plastics recycling system, and any combination thereof.

3. The method according to claim 1, wherein the energy supply of one of all or of a selection of the required energy consumers is one of reduced or increased at a predetermined point in time during the operation and for a predetermined time of operation.

4. The method according to claim 1, wherein the used hierarchy of the energy consumers takes into account at least one of the following relevance classes:
relevance class I for energy consumers that are turned on for the given operating state of the plastics recycling system and are operated continuously with a power of 100%,
relevance class II for energy consumers that are turned on for the given operating state of the plastics recycling system and are operated continuously with a power of less than 100%,
relevance class III for energy consumers that are turned on for the given operating state of the system in clock mode and are operated with a power of 100% in clock mode,
relevance class IV for energy consumers that are turned on for the given operating state of the system in clock mode and are operated with a power of less than 100% in clock mode,
relevance class V for energy consumers that are one of only optional for the given operating state of the system, that only require an insignificant amount of energy, respectively power, e.g. <<1%, and a combination thereof.

5. The method according to claim 1, wherein the one of detection of the energy consumption of each individual energy consumer of the plastics recycling system, the detection of an operating state of the plastics recycling system, the identification of the energy consumers required for the operating state, the creation of a hierarchy of the energy consumers, and any combination thereof includes one of the detection of an input by an operator, the reading out of predetermined parameters from a database regarding the energy consumption of the energy consumer, the operating state of the plastics recycling system, the hierarchy of the energy consumers, and any combination thereof.

6. The method according to claim 1, wherein at least one ambient parameter of the plastics recycling system is measured, and the supply of the required energy consumers with energy is realized by taking into account the at least one ambient parameter.

7. The method according to claim 6, wherein the at least one ambient parameter is one of the ambient temperature, the ambient humidity, the ambient pressure, the time of day, and any combination thereof.

8. A system for recycling plastic, comprising:
a plurality of energy consumers,
at least one intelligent energy management unit in communication with the energy consumers and in communication with one of a central control unit for the energy consumers of the system, a plurality of decentralized control units of the energy consumers of the system, and a combination thereof, and being configured to
detect the energy consumption of each individual energy consumer of the plastics recycling system,
detect the operating state of the plastics recycling system,
identify the energy consumers required for the operating state,
use a hierarchy of the energy consumers depending on one of their energy consumption, their operating mode, the operating state of the plastics recycling system, and any combination thereof, and
the required energy consumers are supplied with energy by taking into account the hierarchy, wherein a maximum peak power which the energy management unit can make available to the entirety of the required energy consumers is smaller than a sum of the rated peak powers of the individual required energy consumers.

9. A system according to claim 8, wherein the energy consumers comprise one or more units from the following list: at least one of disintegrating or washing units for the plastic materials fed to the recycling process, units for conveying at least one of plastic materials or other materials, drive units, stirrer units, ventilation units, fan units, pumping units, filter units, screening units, granulating units, drying units, and extruder units.

10. The method according to claim 4, wherein the used hierarchy of the energy consumers takes into account takes into account one or more of the following criteria:
energy consumer operating time, energy consumer turn-on time, energy demand of the energy consumer, operational readiness requirement of the energy consumer,
and wherein the energy supply of the required energy consumers is realized by taking into account the relevance class assigned to them and/or the last-mentioned criteria
